(19) United States
(12) Patent Application Publication
(10) Pub. No.: US 2013/0312382 A1
(43) Pub. Date: Nov. 28, 2013

(54) LAWN MOWER

(71) Applicant: MAKITA CORPORATION, Aichi (JP)

(72) Inventors: Kiyozumi KOKAWA, Aichi-ken (JP); Kazunori HATTORI, Aichi-ken (JP)

(21) Appl. No.: 13/895,895

(22) Filed: May 16, 2013

(30) Foreign Application Priority Data
May 25, 2012 (JP) 2012-119820
May 25, 2012 (JP) 2012-119822

(51) Int. Cl. A01D 34/82

(52) U.S. Cl. CPC A01D 34/82
USPC 56/17.5

(57) ABSTRACT

A lawn mower may include a main body having first right and left wheels, a mowing blade attached to the main body and configured to be rotated by a power source, and at least one mowing width indicator. The mowing blade is configured such that a mowing width thereof is greater than a distance between inner end surfaces of the first right and left wheels. The at least one mowing width indicator is formed in the first right and left wheels.

### BACKGROUND OF THE INVENTION

1. Field of the Invention

The present invention relates to a lawn mower that is used for manicuring a lawn or other such grass. More particularly, the present invention relates to a push lawn mower that is mainly used outdoors.

2. Description of Related Art

For example, a known electric lawn mower includes a main body having wheels and a handle extending backward and obliquely upward from the main body. In the lawn mower thus constructed, the user can push the main body while grasping the handle, so as to cut a lawn. The main body has a mowing blade that is capable of rotating by an electric motor as a drive source. The electric motor is vertically contained in the main body such that an axis of an output shaft thereof can vertically extend. The mowing blade is attached to the output shaft, so as to horizontally rotate about the axis along a lower surface of the main body.

Such an electric lawn mower is taught by, for example, Japanese Laid-Open Patent Publication No. 11-168938. The lawn mower has a pair of mowing width indicator projections that are disposed on a front portion thereof. In particular, the indicator projections are attached to a front end portion of the main body of the lawn mower, so as to project forwards therefrom. The indicator projections are laterally spaced from each other, so as to correspond to a mowing width of the mowing blade. Thus, the user can easily know the mowing width of the mowing blade.

Generally, it is preferable that the lawn mower has a larger mowing width such that a wide range of mowing can be performed in one operation. However, when the mowing width of the mowing blade is greater than a distance between right and left front wheels, the indicator projections cannot be directly attached to the front end portion of the main body of the lawn mower. In other words, the indicator projections cannot be disposed on the front end portion of the lawn mower in order to show the mowing width of the mowing blade.

Therefore, there is a need in the art for an improved lawn mower having a mowing blade of which the mowing width is greater than a distance between right and left front wheels.

### BRIEF SUMMARY OF THE INVENTION

In one aspect of the present invention, a lawn mower may include a main body having first right and left wheels, a mowing blade attached to the main body and configured to be rotated by a power source, and at least one mowing width indicator. The mowing blade is configured such that a mowing width thereof is greater than a distance between inner end surfaces of the first right and left wheels. The at least one mowing width indicator is formed in the first right and left wheels.

According to this aspect, a user can know or recognize the mowing width of the mowing blade by looking. As a result, the user can properly and quickly perform mowing work. This may lead to improved usability of the lawn mower.

Optionally, the at least one mowing width indicator may include a pair of mowing width indicators that are respectively formed in the first right and left wheels.

Further, each of the mowing width indicators may include an annular rib, a plurality of separate ribs, an indicator strip, an indicator band, an annular groove, or a combination of the indicator strip and the annular groove.

Further, the at least one mowing width indicator may include a single mowing width indicator that is formed in one of right and left side portions of a main body housing of the main body.

Further, the mowing width indicator may include a portion of a side protector, a rod-shaped member or a line-shaped member.

Other objects, features and advantages of the present invention will be readily understood after reading the following detailed description together with the accompanying drawings and the claims.

### BRIEF DESCRIPTION OF THE DRAWINGS

FIG. 1 is a perspective view of a lawn mower according to a first embodiment of the present invention;

FIG. 2 is a cross-sectional view of a main body of the lawn mower;

FIG. 3 is a plan view of the main body of the lawn mower;

FIG. 4 is a vertical cross-sectional view of a front wheel;

FIG. 5 is a perspective view of a front wheel in a first modified form of the first embodiment;

FIG. 6 is a vertical cross-sectional view of a front wheel in a second modified form of the first embodiment;

FIG. 7 is a vertical cross-sectional view of a front wheel in a third modified form of the first embodiment;

FIG. 8 is a vertical cross-sectional view of a front wheel in a fourth modified form of the first embodiment;

FIG. 9 is a vertical cross-sectional view of a front wheel in a fifth modified form of the first embodiment;

FIG. 10 is a perspective view of a lawn mower according to a second embodiment of the present invention;

FIG. 11 is a plan view of a main body of the lawn mower;

FIG. 12 is a schematic plan view of the main body of the lawn mower, in which a mowing width indicator is shown;

FIG. 13 is a perspective view of a main body of a lawn mower in a first modified form of the second embodiment, in which a rod antenna-shaped mowing width indicator is shown; and

FIG. 14 is a perspective view of a main body of a lawn mower in a second modified form of the second embodiment, in which a line-shaped mowing width indicator is shown.

### DETAILED DESCRIPTION OF THE INVENTION

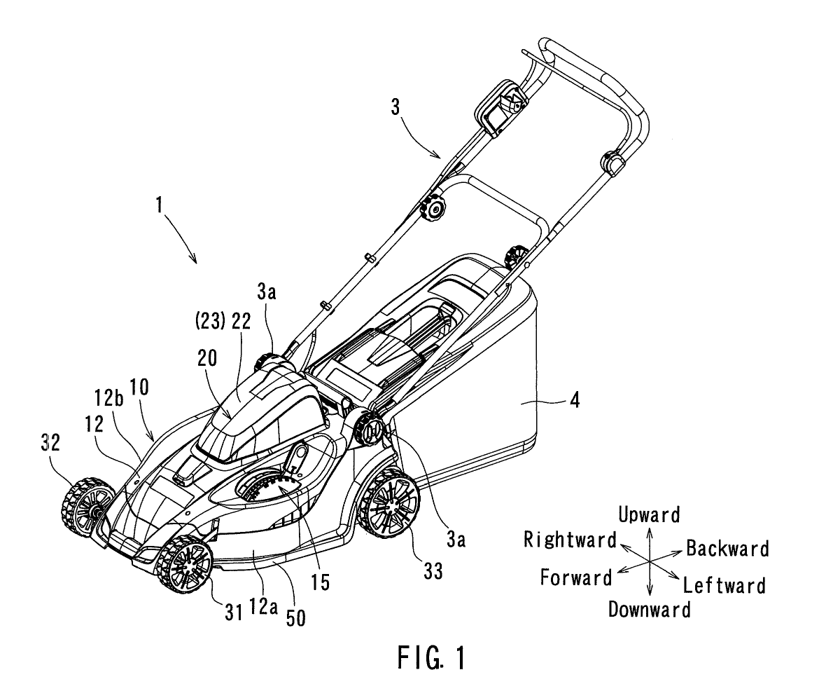

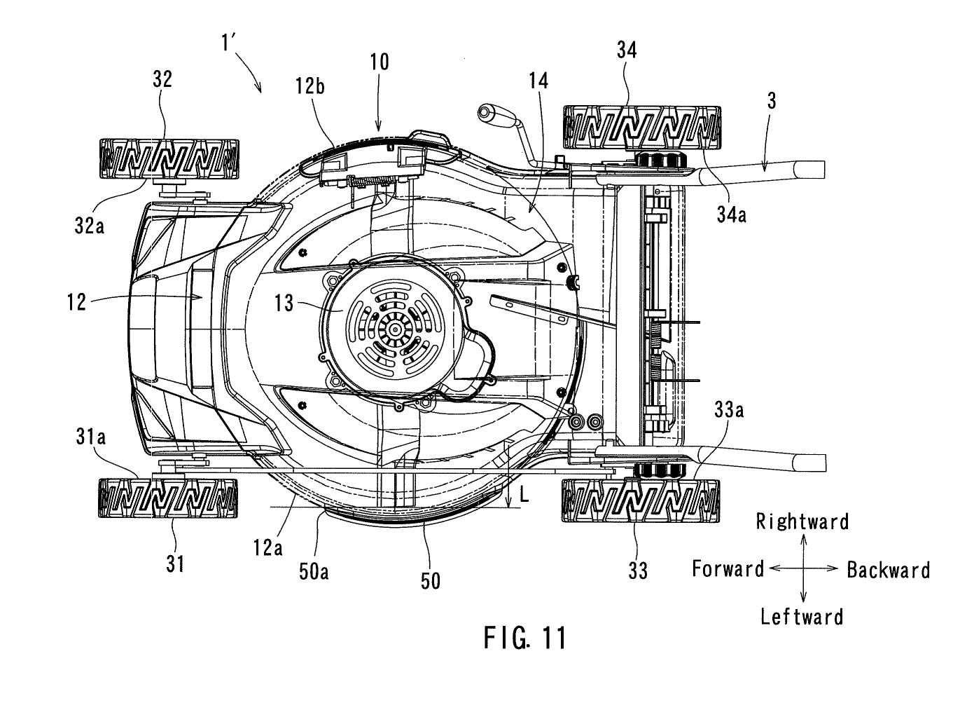

Next, representative embodiments of the present invention will be described in detail with reference to FIGS. 1 to 14.

### First Detailed Representative Embodiment

A first embodiment of the present invention will be described with reference to FIGS. 1 to 9.

As shown in FIG. 1, a lawn mower 1 may include a main body 10 and a frame-shaped handle 3. The main body 10 may have right and left front and rear wheels 31-34 (a left front wheel 31, a right front wheel 32, a left rear wheel 33 and a right rear wheel 34) each of which is formed by resin molding. The main body 10 may have a box-shaped container 4. The container 4 may be attached to a rear portion of the main body 10, so that a mown lawn can be accumulated therein. The handle 3 may be attached to the rear portion of the main body 10 via right and left securing screws 3a and may be extended backward and obliquely upward therefrom above the container 4.

As will be recognized, in order to mow a lawn using the lawn mower 1, a user may stand behind the lawn mower 1 and may push the same forward while gripping the handle 3. Further, the handle 3 is configured to be rotated forward by loosening the securing screws 3a. Therefore, the handle 3 can be folded back onto the main body 10 when the lawn mower 1 is not in use. Further, in the description, rightward and leftward respectively correspond to rightward and leftward with respect to the user.

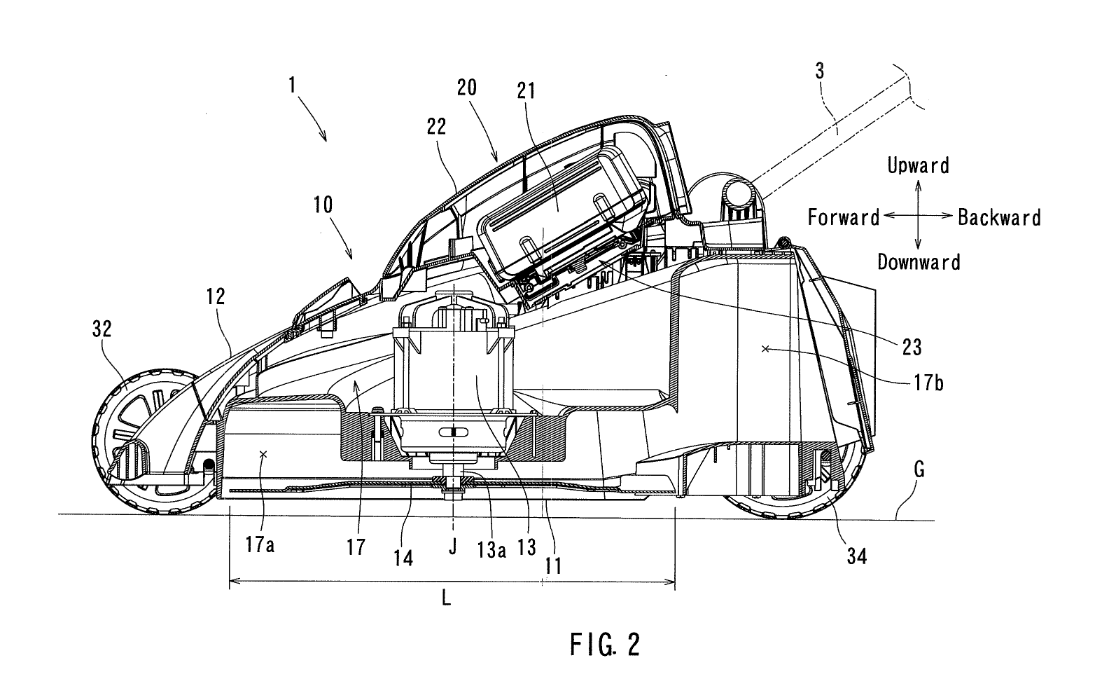

As shown in FIG. 2, the main body 10 may be composed of a deck portion 11 to which the four wheels 31-34 wheels are attached, and a plastic main body housing 12 disposed on and attached to the deck portion 11.

The lawn mower 1 of the present embodiment may be powered by rechargeable batteries as a power source. A battery attachment portion 20 may be attached to a central portion of an upper surface of the main body 10, i.e., an upper surface of the main body housing 12. The battery attachment portion 20 may have a battery cover 22 that is capable of swinging vertically so as to be opened and closed. When the battery cover 22 is swung upward and opened, a battery attachment seat 23 formed in the battery attachment portion 20 can be exposed. A battery pack 21 containing the rechargeable batteries may be attached to the battery attachment seat 23. As shown in FIG. 2, when the battery cover 22 is swung downward and closed after the battery pack 21 is attached to the battery attachment seat 23, the battery attachment seat 23 can be entirely covered by the battery cover 22 while the battery pack 21 is attached thereto.

An example of the battery pack 21 may be a battery pack containing lithium-ion batteries for a battery-powered electric power tool such as an electric screw tightening device and an electric circular saw. Further, in this embodiment, a slide coupling-type battery pack is exemplified as the battery pack 21.

As shown in FIG. 2, the battery attachment seat 23 may be positioned such that the battery pack 21 attached thereto can be positioned above an electric motor 13 attached to the deck portion 11 and behind a motor rotational axis J. That is, the battery attachment seat 23 may be positioned such that the battery pack 21 cannot be positioned directly above the motor 13. Further, the battery attachment seat 23 may be positioned such that the battery pack 21 attached thereto can be obliquely positioned with respect to the motor rotational axis J. In particular, the battery attachment seat 23 may be positioned such that the battery pack 21 can be held in a forward tilting posture in which a rear portion thereof is raised.

In this way, the battery pack 21 may be positioned so as to not be vertically coincident with the motor 13. That is, the battery pack 21 may be positioned so as to be displaced backward from the motor 13. Therefore, the main body 10 including the battery attachment portion 20 can be reduced in height. As a result, the main body 10 can be downsized. Further, the battery pack 21 may be obliquely positioned with respect to the motor rotational axis J with the forward tilting posture. Therefore, the battery pack 21 can be easily attached to and detached from the battery attachment seat 23 by the user positioned behind the handle 3.

Further, the battery attachment seat 23 (the battery attachment portion 20) is attached to the upper surface of the main body housing 12, so as to be separated from the deck portion 11 to which the motor 13 is attached. That is, the battery attachment seat 23 does not directly contact the deck portion 11. Therefore, a vibration generated in the motor 13 can be prevented from being directly transmitted to the battery pack 21 attached to the battery attachment seat 23. Thus, a vibration-proof function may be added to the battery pack 21.

The motor 13 may be attached to a substantially central portion of the deck portion 11. The motor 13 may be positioned in a downward-facing posture such that an output shaft 13a thereof can be directed to a mown surface G (such that the motor rotational axis J can be extended in a direction perpendicular to the mown surface G).

As shown in FIG. 2, the deck portion 11 may have a grass collecting duct 17 that functions to collect the lawn mown by a mowing blade 14. The deck portion 11 may have a cylindrical opening that is formed in a lower surface thereof. The cylindrical opening may be widely opened toward the mown surface G, so as to form a grass collecting port 17a of the grass collecting duct 17. The mowing blade 14 may be horizontally positioned within the grass collecting port 17a. The grass collecting duct 17 may have a spiral shape that is centered on the motor 13. The grass collecting duct 17 thus shaped may be spirally extended backward from a front portion of the grass collecting port 17a. The grass collecting duct 17 may be gradually enlarged upwardly, so as to form an outlet port 17b that is widely opened in the rear portion of the main body 10. The container 4 may be attached to the main body 10 while it is coupled to the outlet port 17b.

The output shaft 13a of the motor 13 may be projected downward beyond the lower surface of the deck portion 11, so as to form a projected portion. The mowing blade 14 may be connected to the projected portion of the motor output shaft 13a, so as to be rotated thereabout. Therefore, the mowing blade 14 can be horizontally rotated along the mown surface G. Thus, the lawn can be mown to a given mowing height (length). As will be appreciated, the mowing height of the lawn may correspond to a vertical distance (height) of the mowing blade 14 from the mown surface G. Further, the mowing height of the lawn can be voluntarily variously changed by a mowing height adjusting mechanism 15 (FIG. 1) which is a known mechanism. In particular, the moving height adjusting mechanism 15 may be configured to vertically change a position (height) of each of the wheels 31-34 (a lawn mower height) relative to the deck portion 11, so as to change the height of the mowing blade 14 relative to the mown surface G.

Right and left end portions of the mowing blade 14 may be covered by right and left side portions 12a and 12b of the main body housing 12. Further, the main body housing 12 may have elastomer side protectors 50 that are respectively attached to the right and left side portions 12a and 12b of the main body housing 12. The side protectors 50 attached to the main body housing 12 may function to effectively absorb an impact generated in the event of a side collision of the lawn mower 1 (e.g., when the lawn mower 1 collides against a wall, a fence or other such things), so as to protect the mowing blade 14 from being damaged.

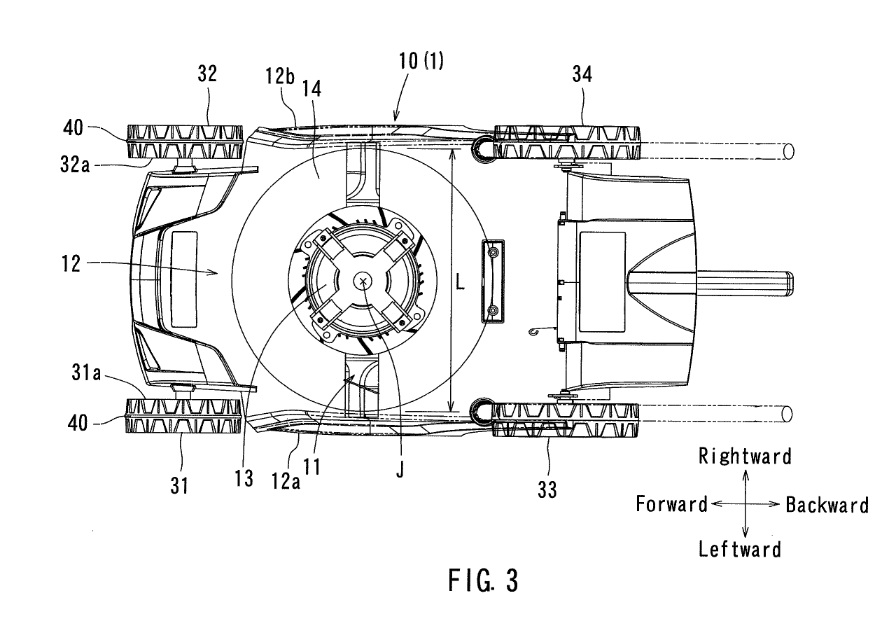

As shown in FIG. 2, the mowing blade 14 may be a large-size rotary blade having a mowing width (diameter) L. As shown in FIG. 3, the mowing blade 14 may be configured such that the mowing width L thereof is greater than a distance between inner end surfaces 31a and 32a of the front wheels 31 and 32. As a result, right and left end edges of the mowing blade 14 (both ends of the mowing width L) may be laterally projected beyond the inner end surfaces 31a and 32a of the front wheels 31 and 32.

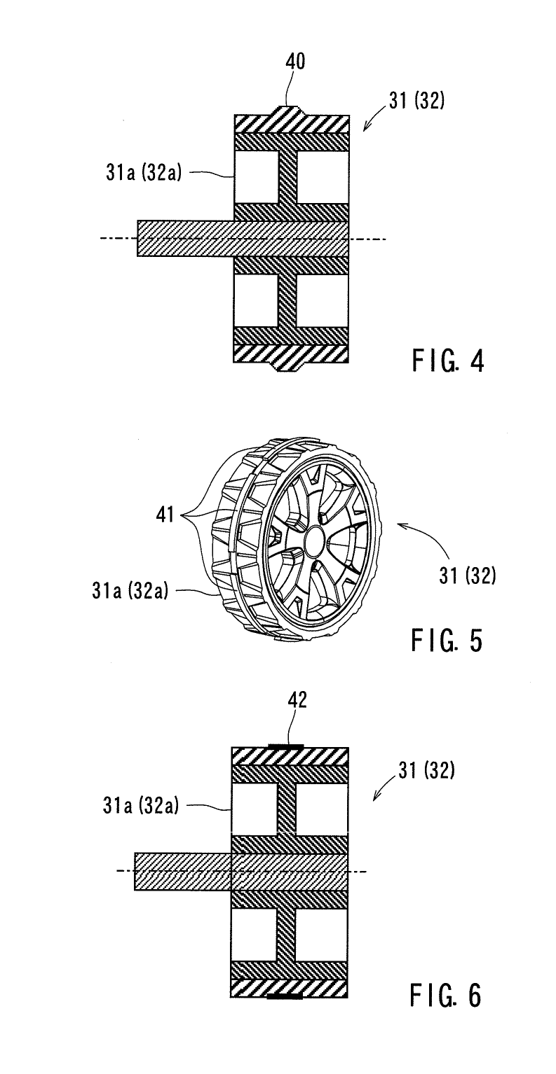

The lawn mower 1 of the present embodiment may have mowing width indicators 40 such that the user can recognize the both (right and left) ends of the mowing width L of the mowing blade 14 (the end edges of the mowing blade 14) by looking. As shown in FIG. 3, the mowing width indicators 40 may be formed in the front wheels 31 and 32. As best shown in FIG. 4, each of the mowing width indicators 40 may be composed of a continuous annular rib that is circumferentially integrally formed in an outer circumferential surface each of the front wheels 31 and 32 over an entire circumference thereof. The mowing width indicators 40 may be positioned so as to respectively be aligned with the both ends of the mowing width L of the mowing blade 14 in a front-back direction of the main body 10 (FIG. 3). Thus, the user can easily know the right end and/or the left end of the mowing width L of the mowing blade 14 by looking at one or both of the mowing width indicators 40 formed in the front wheels 31 and 32.

According to the lawn mower 1 thus constructed, each of the mowing width indicators 40 is formed in the outer circumferential surface (a ground contact area) of each of the front wheels 31 and 32. Therefore, the user can instantly know the right and left ends of the mowing width L of the mowing blade 14 by looking at the mowing width indicators 40. As a result, the user can properly and quickly perform mowing work. This may lead to improved usability of the lawn mower 1. In particular, even when the mowing work is performed by the fence, the user can quickly and neatly manicure the lawn because the user can precisely known the ends of the mowing width L of the mowing blade 14.

Further, because the mowing width indicators 40 are formed in the right and left front wheels 31 and 32, the user can quickly and precisely move the lawn mower 1 to a mowing work start position and position the same thereon.

In addition, each of the mowing width indicators 40 (the annular rib) can function as an antislip device to prevent each of the front wheels 31 and 32 from laterally slipping because it is formed in the outer circumferential surface of each of the front wheels 31 and 32.

Various changes and modifications may be made to the present embodiment. For example, in the embodiment, the mowing width indicators 40 (the ribs) are formed in both of the front wheels 31 and 32. However, a single indicator (a rib) can be formed in only one of the front wheels 31 and 32.

Further, in the embodiment, each of the mowing width indicators 40 (the annular rib) is continuously formed in the outer circumferential surface of each of the front wheels 31 and 32. However, as shown in FIG. 5, the mowing width indicators 40 can respectively be modified to mowing width indicators 41 (a first modified form). In the first modified form, each of the mowing width indicators 41 may be composed of a plurality of separate ribs that are discontinuously or separately formed in the outer circumferential surface of each of the front wheels 31 and 32.

Further, as shown in FIG. 6, the mowing width indicators 40 can respectively be modified to mowing width indicators 42 (a second modified form). In the second modified form, each of the mowing width indicators 42 may be composed of a continuous annular indicator strip that is applied or adhered to the outer circumferential surface of each of the front wheels 31 and 32 so as to extend over the entire circumference thereof. The indicator strip may preferably be colored white in order to increase visibility thereof.

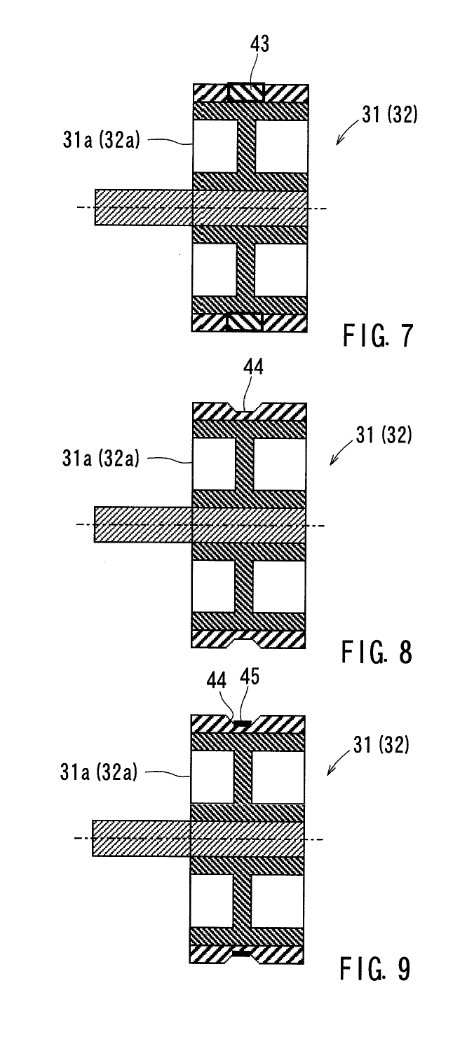

Further, as shown in FIG. 7, the mowing width indicators 40 can respectively be modified to mowing width indicators 43 (a third modified form). In the third modified form, unlike each of the mowing width indicators 40, each of the mowing width indicators 43 may be composed of a continuous annular indicator band that is embedded in the outer circumferential surface of each of the front wheels 31 and 32 so as to extend over the entire circumference thereof. The indicator band may preferably made of a material different from the outer circumferential wall of each of the front wheels 31 and 32. The indicator band may have a rectangular shape in cross section. Preferably, the indicator band may be simultaneously formed by two-color molding when the outer circumferential wall of each of the front wheels 31 and 32 is molded.

Further, as shown in FIG. 8, the mowing width indicators 40 can respectively be modified to mowing width indicators 44 (a fourth modified form). In the fourth modified form, each of the mowing width indicators 44 may be composed of a continuous annular groove that is formed in the outer circumferential surface of each of the front wheels 31 and 32 so as to extend over the entire circumference thereof.

Further, as shown in FIG. 9, the fourth modified form can be further modified (a fifth modified form). In the fifth modified form, mowing width indicators 45 are respectively added to the mowing width indicators 44 (the annular groove) in the fourth modified form. That is, the mowing width indicators 40 can respectively be modified to combinations of the mowing width indicators 44 and the mowing width indicators 45. Each of the mowing width indicators 45 may be composed of a continuous annular indicator strip that is disposed in the annular groove formed in each of the front wheels 31 and 32. The indicator strip may preferably be formed in a bottom surface of the annular groove by painting, preferably by white painting. This modified form may provide increased visibility by combining the mowing width indicators 44 (the annular groove) with the mowing width indicators 45 (the indicator strip).

### Second Detailed Representative Embodiment

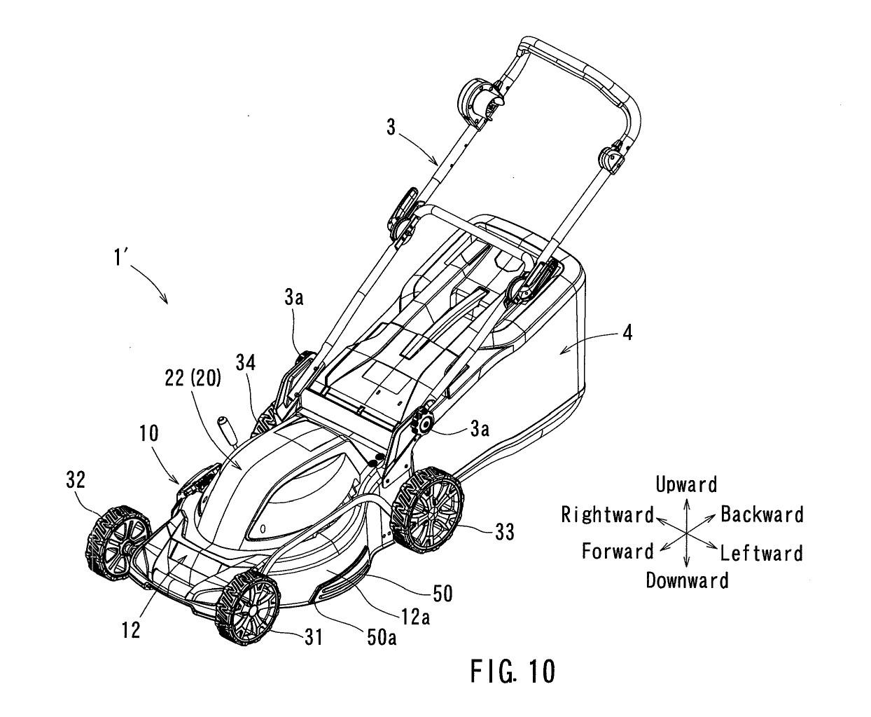

A second embodiment of the present invention will now be described in detail with reference to FIGS. 10 to 14.

Because the second embodiment relates to the first embodiment, only the constructions and elements that are different from the first embodiment will be explained in detail. Elements that are the same in the first and second embodiments will be identified by the same reference numerals and a detailed description of such elements may be omitted.

As shown in FIG. 10, a lawn mower 1′ of the second embodiment may have a mowing width indicator (mark) 50a. Unlike the first embodiment, the mowing width indicator 50a may be formed in one of the right and left side portions 12a and 12b of the main body housing 12. In particular, the mowing width indicator 50a may be formed in the side protector 50 that is attached to the left side portion 12a of the main body housing 12. That is, the mowing width indicator 50a may be defined by a front end portion of the side protector 50. As will be recognized, the side protector 50 may be appropriately positioned such that the mowing width indicator 50a (the front end portion thereof) can be aligned with the left end edge of the mowing width L of the mowing blade 14.

In this embodiment, the mowing width indicator 50a (the side protector 50) may preferably have a color (black) different from a color (blue) of the left side portion 12a (the main body housing 12). This means that the mowing width indicator 50a can be positioned on a background with a different color. Therefore, the user can easily visibly recognize the mowing width indicator 50a, so as to recognize the left end of the mowing width L of the mowing blade 14 by looking.

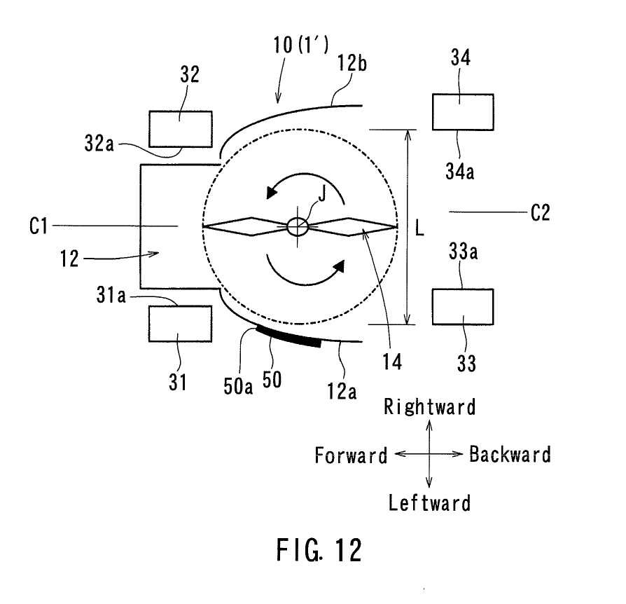

Further, as shown in FIG. 12, in the embodiment, the right and left front wheels 31 and 32 may be positioned such that a midpoint C1 between the inner end surfaces 31a and 32a thereof can be aligned with a rotational axis J of the mowing blade 14 in the front-back direction of the main body 10, whereas the right and left rear wheels 33 and 34 may be positioned such that a midpoint C2 between inner end surfaces 33a and 34a thereof can be displaced rightward from the rotational axis J of the mowing blade 14. As a result, the midpoint C1 between the inner end surfaces 31a and 32a of the front wheels 31 and 32 may be slightly displaced or offset leftward from the midpoint C2 between the inner end surfaces 33a and 34a of the rear wheels 33 and 34. In other words, the front wheels 31 and 32 may be displaced or offset leftward from the rear wheels 33 and 34.

Thus, the mowing width indicator 50a may be formed in the side protector 50 attached to the main body housing left side portion 12a positioned in a direction in which the front wheels 31 and 32 (the midpoint C1) are offset or displaced from the rear wheels 33 and 34 (the midpoint C2). Generally, the user may be positioned on a longitudinal line passing through the midpoint C2 between the inner end surfaces 33a and 34a of the rear wheels 33 and 34. As a result, the mowing width indicator 50a may be positioned on the main body housing left side portion 12a which is further away from the user (the midpoint C2). Therefore, the user can easily recognize the left end of the mowing width L which is further away from the user.

In the lawn mower 1′ of the second embodiment, the mowing width indicator 50a is formed in the side protector 50 that is positioned behind the front wheels 31 and 32. Therefore, it is not necessary to provide the lawn mower 1′ with an additional member (e.g., a front bumper) in which the mowing width indicator 50a should be formed. As a result, the mowing width indicator 50a can be formed in the lawn mower 1′ without increasing a length of the lawn mower 1′.

Further, because the color of the side protector 50 is different from the color of the left side portion 12a of the main body housing 12, the mowing width indicator 50a formed in the front end portion of the side protector 50 can be further clearly distinguished from the left side portion 12a. Therefore, the user can easily recognize the mowing width indicator 50a even in the faint light, e.g., early-evening. As a result, the user can effectively and quickly perform the mowing work.

Various changes and modifications may be made to the present embodiment. For example, in the embodiments, the mowing width indicator 50a may be formed in only the side protector 50 attached to the left side portion 12a of the main body housing 12. However, an additional mowing width indicator (not shown) can be formed in the side protector attached to the right side portion 12b of the main body housing 12. That is, two mowing width indicator can respectively be formed in both of the right and left side portions 12a and 12b of the main body housing 12.

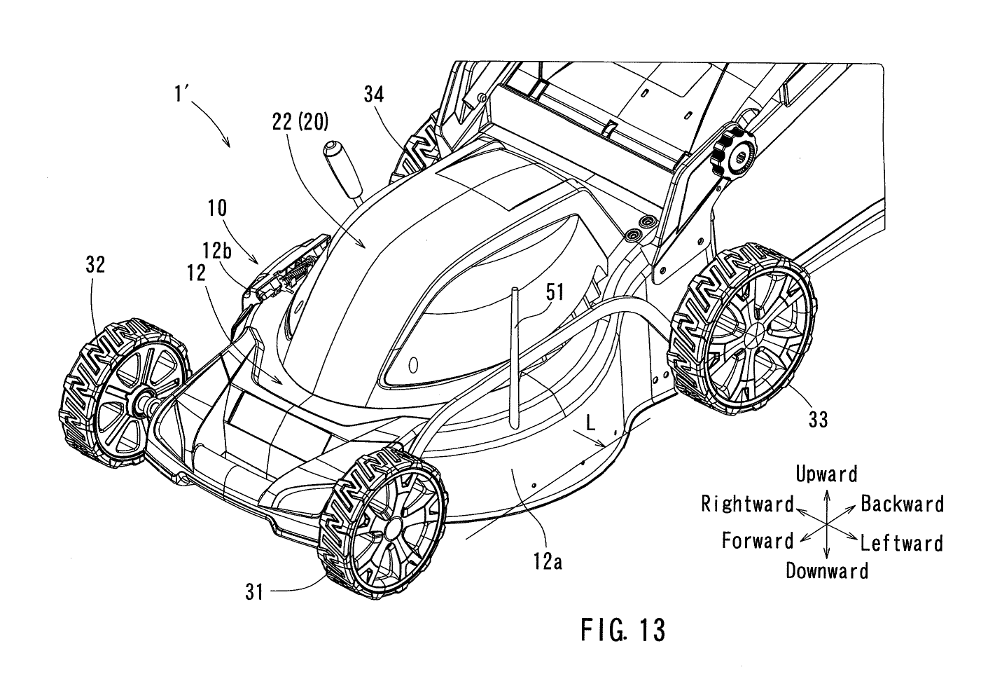

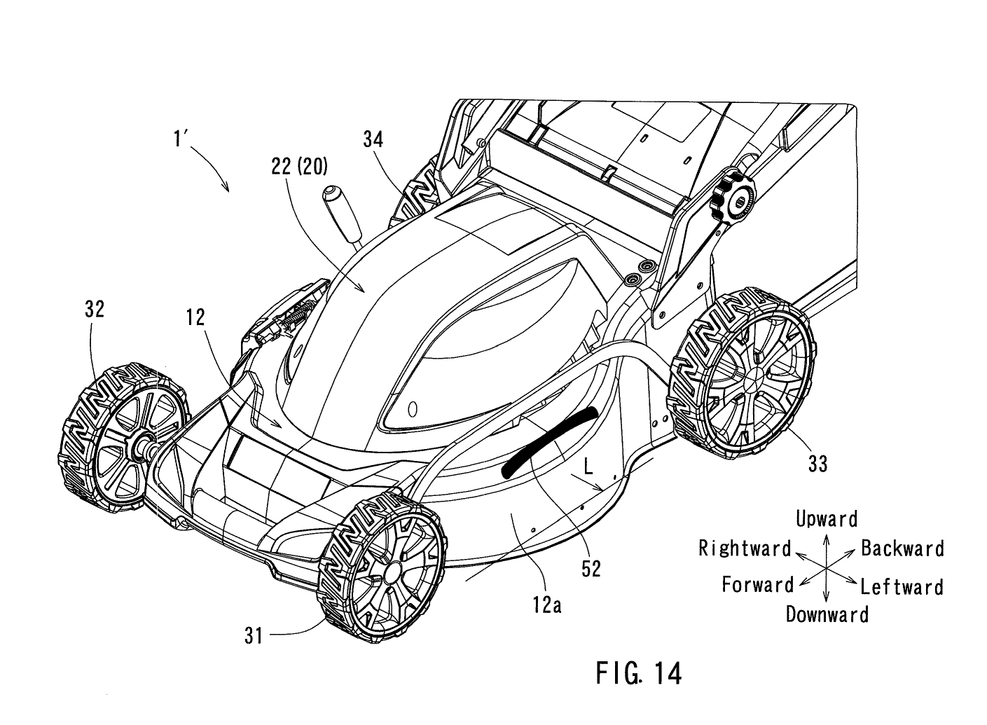

Further, in the embodiment, the mowing width indicator 50a is defined by the front end portion of the side protector 50. However, the mowing width indicator 50a can be variously modified. For example, as shown in FIG. 13, the mowing width indicator 50a can be replaced with a mowing width indicator 51. The mowing width indicator 51 may be composed of a rod-shaped member that is vertically attached to the left side portion 12a of the main body housing 12. The mowing width indicator 51 thus shaped may be appropriately positioned so as to be aligned with the left end edge of the mowing width L of the mowing blade 14. Alternatively, as shown in FIG. 14, the mowing width indicator 50a can be replaced with a mowing width indicator 52. The mowing width indicator 52 may be composed of a line-shaped member that is formed in the left side portion 12a of the main body housing 12. The mowing width indicator 52 thus formed may be appropriately positioned so as to be aligned with the left end edge of the mowing width L of the mowing blade 14.

Further, each of the rod-shaped mowing width indicator 51 and the line-shaped mowing width indicator 52 may have a color different from the color of the left side portion 12a of the main body housing 12 such that the left end of the mowing width L of the mowing blade 14 can be easily recognized by looking. In addition, an additional rod-shaped mowing width indicator (not shown) can be attached to the right side portion 12b of the main body housing 12. Similarly, an additional line-shaped mowing width indicator (not shown) can be formed in the right side portion 12b of the main body housing 12. Further, each of the rod-shaped mowing width indicator 51 and the line-shaped mowing width indicator 52 can be attached to the right side portion 12b instead of the left side portion 12a as necessary.

Further, in the embodiment, the mowing width indicator 50a is formed in the side protector 50 that is attached to the left side portion 12a of the main body housing 12. However, the mowing width indicator 50a can be replaced with an another mowing width indicator that is directly formed in the left side portion 12a of the main body housing 12. An example of such an another mowing width indicator is an arrow line painted on the left side portion 12a of the main body housing.

Further, in the lawn mowers 1 and 1′ of the first and second embodiments, the rotary blade that is horizontally rotatable is exemplified as the mowing blade 14. However, the present invention can be applied to a reel-type lawn mower having a spinning blade that is rotatable about a horizontal axis parallel to the mown surface G.

Further, each of the lawn mowers 1 and 1′ exemplified in the first and second embodiments is configured such that the battery pack for the battery-powered electric power tool such as the electric screw tightening device can be used as the power source. However, the present invention can be applied to a battery-powered lawn mower having an internal special battery, a lawn mower power by an AC source and a lawn mower powered by an engine (an internal combustion engine).

Further, each of the lawn mowers 1 and 1′ has the four wheels (the right and left front wheels 31 and 32 and the right and left rear wheels 33 and 34). However, the present invention can be applied to a lawn mower having only two wheels (i.e., an upright lawn mower). Also, the present invention can be applied to a lawn mower having two wheels (right and left front wheels) and a single roller (a rear roller).

Representative examples of the present invention have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A lawn mower, comprising:
a main body having first right and left wheels,
a mowing blade attached to the main body and configured to be rotated by a power source, and
at least one mowing width indicator,
wherein the mowing blade is configured such that a mowing width thereof is greater than a distance between inner end surfaces of the first right and left wheels, and
wherein the at least one mowing width indicator is formed in the first right and left wheels.

2. The lawn mower as defined in claim 1, wherein the at least one mowing width indicator comprises a pair of mowing width indicators that are respectively formed in the first right and left wheels.

3. The lawn mower as defined in claim 2, wherein each of the mowing width indicators comprises an annular rib that is circumferentially continuously formed in each of the first right and left wheels.

4. The lawn mower as defined in claim 2, wherein each of the mowing width indicators comprises a plurality of separate ribs that are circumferentially discontinuously formed in each of the first right and left wheels.

5. The lawn mower as defined in claim 2, wherein each of the mowing width indicators comprises an indicator strip that is circumferentially applied to each of the first right and left wheels.

6. The lawn mower as defined in claim 2, wherein each of the mowing width indicators comprises an indicator band that is circumferentially embedded in each of the first right and left wheels.

7. The lawn mower as defined in claim 2, wherein each of the mowing width indicators comprises an annular groove that is circumferentially formed in each of the first right and left wheels.

8. The lawn mower as defined in claim 2, wherein each of the mowing width indicators comprises a combination of an annular groove that is circumferentially formed in each of the first right and left wheels and an annular indicator strip that is disposed in the annular groove.

9. A lawn mower, comprising:
a main body having first right and left wheels,
a mowing blade attached to the main body and configured to be rotated by a power source, and
at least one mowing width indicator,
wherein the mowing blade is configured such that a mowing width thereof is greater than a distance between inner end surfaces of the first right and left wheels, and
wherein the at least one mowing width indicator is formed in right and left side portions of a main body housing of the main body which cover the mowing blade.

10. The lawn mower as defined in claim 9, wherein the at least one mowing width indicator comprises a single mowing width indicator that is formed in one of the right and left side portions of the main body housing.

11. The lawn mower as defined in claim 10, wherein the single mowing width indicator comprises a portion of a side protector that is attached to one of the right and left side portions of the main body housing.

12. The lawn mower as defined in claim 11, wherein the side protector has a color different from a color of one of the right and left side portions of the main body housing.

13. The lawn mower as defined in claim 10, wherein the single mowing width indicator comprises a rod-shaped member that is attached to one of the right and left side portions of the main body housing.

14. The lawn mower as defined in claim 10, wherein the single mowing width indicator comprises a line-shaped member that is formed in one of the right and left side portions of the main body housing.

15. The lawn mower as defined in claim 10, wherein the main body has second right and left wheels positioned behind the first right and left wheels, wherein the first right and left wheels are positioned such that a midpoint between inner end surfaces thereof can be aligned with a rotational axis of the mowing blade in a front-back direction of the main body, whereas the second right and left wheels are positioned such that a midpoint between inner end surfaces thereof can be laterally displaced from the rotational axis of the mowing blade.

16. The lawn mower as defined in claim 15, wherein the mowing width indicator is formed in one of the right and left side portions of the main body housing which is further away from the midpoint between the inner end surfaces of the second right and left wheels.
